(19) United States
(12) Patent Application Publication
(10) Pub. No.: US 2017/0058784 A1
(43) Pub. Date: Mar. 2, 2017

(54) SYSTEM AND METHOD FOR MAINTAINING EMISSIONS COMPLIANCE WHILE OPERATING A GAS TURBINE AT TURNDOWN CONDITION

(71) Applicant: General Electric Company, Schenectady, NY (US)

(72) Inventors: Daniel Doyle Vandale, Greenville, SC (US); Michael Anthony Cocca, Atlanta, GA (US); Joseph Phillip Klosinski, Atlanta, GA (US); Mihir Kumar Lal, Greer, SC (US); James Harper, Greenville, SC (US)

(21) Appl. No.: 15/237,726

(22) Filed: Aug. 16, 2016

Related U.S. Application Data
(60) Provisional application No. 62/210,636, filed on Aug. 27, 2015.

(51) Int. Cl. F02C 9/18; F02C 7/228; F23R 3/34; F01D 25/30; F01N 3/10; F04D 29/32; F04D 29/54; F01D 5/02; F02C 3/04; F02C 3/30

(52) U.S. Cl. CPC F02C 9/18; F02C 3/04; F02C 7/228; F23R 3/346; F02C 3/30; F01N 3/106; F04D 29/321; F04D 29/541; F01D 5/02; F01D 25/30; F05D 2220/32; F05D 2270/08; F05D 2270/54

(57) ABSTRACT

A system and related method for maintaining emissions compliance while operating a gas turbine in turndown mode are disclosed herein. The system includes a gas turbine including a compressor, a combustor, a turbine and an exhaust section. The combustor comprises a plurality of axially staged fuel injectors positioned downstream from a plurality of primary fuel nozzles and a center fuel nozzle. The gas turbine further comprises a bleed air extraction port that is in fluid communication with at least one of the compressor, a compressor discharge casing or the combustor. The system further includes a controller programmed to bleed compressed air from the bleed air extraction port and to energize the plurality of axially staged fuel injectors during turndown operation of the gas turbine.

### CROSS REFERENCE TO RELATED APPLICATIONS

The present application claims filing benefit of U.S. Provisional Patent Application Ser. No. 62/210,636 having a filing date of Aug. 27, 2015, which is incorporated by reference herein in its entirety.

### FIELD OF THE INVENTION

The present invention generally relates to a gas turbine power plant such as a combined cycle or cogeneration power plant having a steam source and a Dry Low NOx (DLN) combustion system. More particularly, the present invention relates to a system and method for maintaining emissions compliance while operating a gas turbine in turndown mode.

### BACKGROUND OF THE INVENTION

A gas turbine power plant such as a combined cycle or cogeneration power plant generally includes a gas turbine having a compressor, a combustor and a turbine, a heat recovery steam generator (HRSG) that is disposed downstream from the turbine and a steam turbine in fluid communication with the HRSG. During operation, air enters the compressor via an inlet system and is progressively compressed as it is routed towards a compressor discharge or diffuser casing that at least partially surrounds the combustor. At least a portion of the compressed air is mixed with a fuel and burned within a combustion chamber defined within the combustor, thereby generating high temperature and high pressure combustion gases.

The combustion gases are routed along a hot gas path from the combustor through the turbine where they progressively expand as they flow across alternating stages of stationary vanes and rotatable turbine blades which are coupled to a rotor shaft. Kinetic energy is transferred from the combustion gases to the turbine blades thus causing the rotor shaft to rotate. The rotational energy of the rotor shaft may be converted to electrical energy via a generator. The combustion gases exit the turbine as exhaust gas and the exhaust gas enters the HRSG. Thermal energy from the exhaust gas is transferred to water flowing through one or more heat exchangers of the HRSG, thereby producing superheated steam. The superheated steam is then routed into the steam turbine which may be used to generate additional electricity, thus enhancing overall power plant efficiency.

Regulatory requirements for low emissions from gas turbine based power plants have continually grown more stringent over the years. Environmental agencies throughout the world are now requiring even lower levels of emissions of oxides of nitrogen (NOx) and other pollutants and carbon monoxide (CO) from both new and existing gas turbines. In order to balance fuel efficiency with emissions requirements, various types of gas turbines utilize a Dry Low NOx (DLN) type combustion system which utilizes lean premix combustion technology.

A DLN-1 or DLN-1+ type combustor by General Electric Company, Schenectady, N.Y., is a two-stage pre-mixed combustor designed for use with natural gas fuel and may be capable of operation on liquid fuel. The DLN-1 or DLN-1+ type combustor provides a fuel injection system including a secondary fuel nozzle positioned on the center axis of the combustor surrounded by a plurality of primary fuel nozzles annularly arranged around the secondary fuel nozzle. During base load or peak load, the DLN-1 or DLN-1+ type combustor may be configured to maintain very low exhaust emission levels while maintaining high levels of efficiency using lean premixed fuel/air concepts.

It is generally desirable for operators to turn down the gas turbine during times when power generation is not needed, thus potentially saving fuel and allowing for quick recovery time when power is needed again. However, at low-load levels such as during turndown operation the DLN-1 or DLN-1+ combustion system generally requires an inlet air bleed heating system to achieve extended turndown NOx compliance. Inlet bleed heating systems add additional costs to power plant operations. Accordingly, there is a need to provide a system and method which allows for the elimination of an inlet bleed heating system for DLN gas turbine turndown NOx emissions compliance.

### BRIEF DESCRIPTION OF THE INVENTION

Aspects and advantages of the invention are set forth below in the following description, or may be obvious from the description, or may be learned through practice of the invention.

One embodiment of the present invention is a system for maintaining emissions compliance while operating a gas turbine in turndown mode. The system includes a gas turbine including, in serial flow order, a compressor, a combustor, a turbine and an exhaust section. The combustor comprises a plurality of axially staged fuel injectors positioned downstream from a plurality of primary fuel nozzles and a center fuel nozzle. The gas turbine further comprises a bleed air extraction port that is in fluid communication with at least one of the compressor, a compressor discharge casing or the combustor. The system further includes a controller programmed to bleed compressed air from the bleed air extraction port and to energize the plurality of axially staged fuel injectors during turndown operation of the gas turbine.

Another embodiment of the present disclosure includes a method for maintaining emissions compliance while operating a gas turbine in turndown mode. The method includes burning a fuel to generate a flow of combustion gases through a hot gas path of a combustor where the fuel is burned in at least one of a primary combustion zone and a secondary combustion zone of the combustor and where the primary combustion zone and the secondary combustion zone are formed upstream from a plurality of axially staged fuel injectors. The method also includes extracting bleed air from at least one extraction port fluidly coupled to a compressor, the combustor or a turbine of the gas turbine and energizing the plurality of axially staged fuel injectors.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a functional block diagram of an exemplary gas turbine based power plant within the scope of the present invention;

FIG. 2 is a simplified cross sectioned side view of an exemplary Dry Low NOx combustor according to at least one embodiment of the present invention; and

FIG. 3 provides a block diagram of one method for maintaining emissions compliance while operating a gas turbine in turndown mode according to one embodiment of the present disclosure.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components. The terms “upstream” and “downstream” refer to the relative direction with respect to fluid flow in a fluid pathway. For example, “upstream” refers to the direction from which the fluid flows, and “downstream” refers to the direction to which the fluid flows.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, “gas turbine load” or “load” may relate to the power output of a gas turbine's generator(s); “inlet guide vane angle” means the angles of inlet vanes (not shown) relative to axial flow through the inlet system upstream from the compressor; “inlet bleed heat” means the amount of heat in fluid extracted from a downstream portion of the compressor section and inserted into the inlet system or an upstream portion of the compressor section to heat the flow therein; “fuel split” means the amount of fuel sent to different circuits within the combustor and “emissions” or “emissions level” means levels of various exhaust gases including but not limited to oxides of nitrogen (NOx), unburned hydrocarbons and carbon monoxide (CO).

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

An embodiment of the present invention takes the form of a system and method for maintaining NOx emissions compliance while operating the gas turbine in a turndown operating condition. In particular embodiments, the disclosure provides a power plant having a compressor, a combustor downstream from the compressor, at least one bypass or bleed air extraction port in fluid communication with the compressor or the combustor and a plurality of fuel injectors axially staged downstream from a secondary or premix combustion zone of the combustor.

In operation, this invention incorporates axial fuel staging combined with bleed air extraction in order to eliminate the need for inlet bleed heating during turndown operation. Axial fuel staging enables the combustor to achieve NOx emissions compliance at turndown levels which are significantly lower than gas turbine systems without axial fuel staging. The bleed air extraction will allow additional turndown below the level that axial fuel staging enables by bypassing compressed air away from the combustor at low fuel flow levels, thereby preventing blowout and/or over pressurization. This invention may also allow inlet guide vanes to remain open at angles that do not pose an icing risk, while at the same time allowing the combustion system to operate at low loads in NOx emissions compliance.

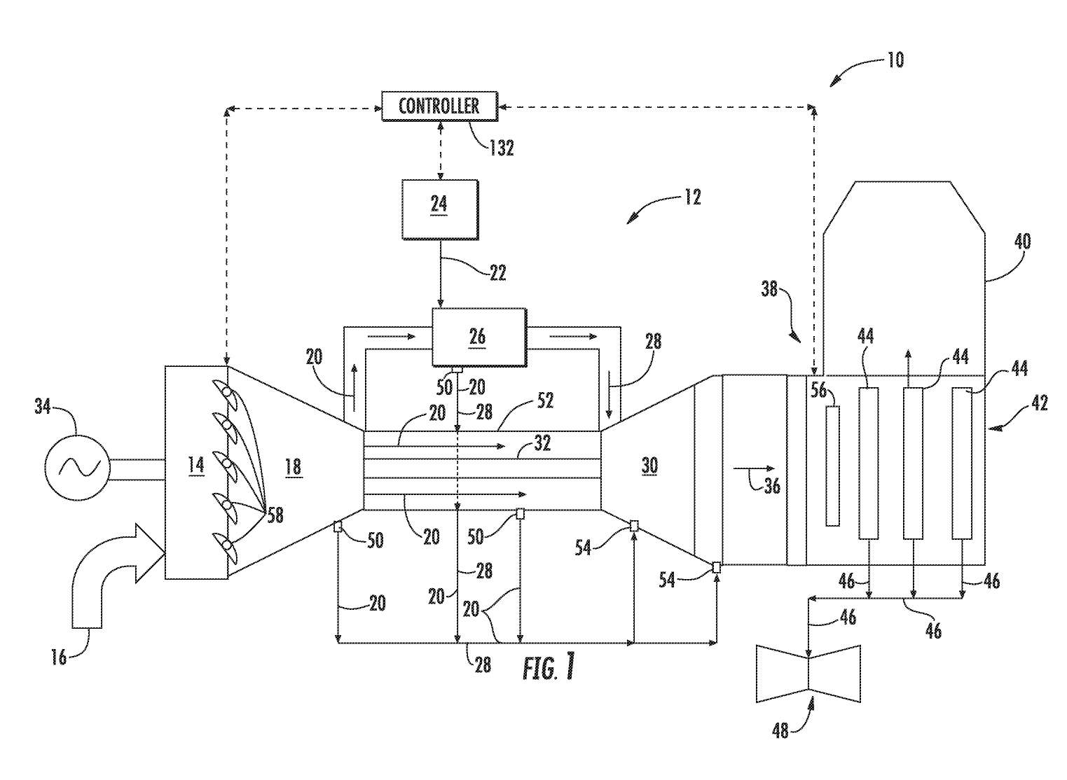

Referring now to the drawings, wherein identical numerals indicate the same elements throughout the figures, FIG. 1 provides a functional block diagram of an exemplary gas turbine power plant 10 with steam production capability. The power plant 10 comprises a gas turbine 12 that may incorporate various embodiments of the present invention. As shown, the gas turbine 12 generally includes an inlet system 14 that may include a series of filters, cooling coils, moisture separators, and/or other devices (not shown) to purify and otherwise condition air 16 or other working fluid entering the gas turbine 12. The air 16 flows to a compressor section where a compressor 18 progressively imparts kinetic energy to the air 16 to produce compressed air as indicated schematically by arrows 20.

The compressed air 20 is mixed with a fuel 22 such as natural gas from a fuel supply system 24 to form a combustible mixture within one or more combustors 26. The combustible mixture is burned to produce combustion gases as indicated schematically by arrows 28 having a high temperature, pressure and velocity. The combustion gases 28 flow through a turbine 30 of a turbine section to produce work. For example, the turbine 30 may be connected to a shaft 32 so that rotation of the turbine 30 drives the compressor 18 to produce the compressed air 20. Alternately or in addition, the shaft 32 may connect the turbine 30 to a generator 34 for producing electricity.

Exhaust gases 36 from the turbine 30 flow through an exhaust section 38 that connects the turbine 30 to an exhaust stack 40 downstream from the turbine 30. The exhaust section 38 may include, for example, a heat recovery steam generator (HRSG) 42 for cleaning and extracting additional heat from the exhaust gases 36 prior to release to the environment. For example, the HRSG 42 may include one or more heat exchangers 44 in thermal communication with the exhaust gases 36 and which may generate steam or superheated steam as indicated schematically by arrows 46. The steam 46 may then be routed to various components at the power plant 10 such as to one or more steam turbines 48 and/or to various heating systems (not shown).

In various embodiments, the gas turbine 12 may include one or more bleed or bypass air extraction ports 50. In particular embodiments, as illustrated in FIG. 1, at least one bleed air extraction port 50 provides a flow path out of the compressor 18 upstream from a compressor discharge or diffuser casing 52. In particular embodiments, as illustrated in FIG. 1, at least one bleed air extraction port 50 provides a flow path out of the compressor discharge casing 52. In particular embodiments, the bleed air extraction port(s) 50 may be used to reduce pressure within the combustor 26 such as during a non-premix mode of operation. In various embodiments, the gas turbine 12 may include at least one bleed or bypass air inlet port 54.

The bleed air extraction ports 50 may be in fluid communication with various external components. For example, in one embodiment, at least one bleed air extraction port 50 may be in fluid communication with the turbine 30 via various fluid conduits, couplings, valves and/or at least one bleed air inlet port 54. In this manner, a portion of the compressed air 20 from the compressor 18 and/or the compressor discharge casing 52 may be routed to the turbine 30 to provide cooling to various components of the turbine 30 and/or to reduce pressure within the combustor 26 and/or the compressor discharge casing 52. In particular embodiments, at least one bleed air extraction port 50 may be in fluid communication with the exhaust section 38 upstream from the HRSG 42 via various fluid conduits, couplings, valves and/or at least one bleed air inlet port 54. In this manner, a portion of the compressed air 20 from the compressor 18 and/or the compressor discharge casing 52 may be routed to the exhaust section 38 to provide thermal energy to the heat exchangers 44 of the HRSG 42 and/or to provide cooling to various components of the exhaust section 38 and/or to reduce pressure within the combustor 26 and/or the compressor discharge casing 52.

In particular embodiments, an oxidation catalyst module or system 56 may be positioned downstream from the turbine 30 and upstream from the exhaust stack 40. The oxidation catalyst system 56 may be used to reduce or potentially eliminate carbon monoxide (CO), unburned hydrocarbons or other undesirable emissions contained within the exhaust gases 36 flowing from the turbine 30.

In various embodiments, the compressor 18 includes a plurality of variable angle inlet guide vanes 58 disposed at an inlet of the compressor 18. The guide vanes 58 may be rotated about a radial axis between an open and a closed positioned. The angle of the inlet guide vanes 58 can be changed to meet the air flow requirements of the engine-operating conditions. For example, the inlet guide vanes 58 may be closed or at least partially closed to restrict air flow to the compressor 18 and the combustor 26 during engine start-up and at low-load or low RPMs. The inlet guide vanes 58 may be progressively opened to increase air flow to the compressor 18 and/or the combustor 26 as the load or RPMs are increased. During start up and at low-load conditions, the angle of attack of the inlet guide vanes 58 is angled so as to avoid stalling the compressor 18.

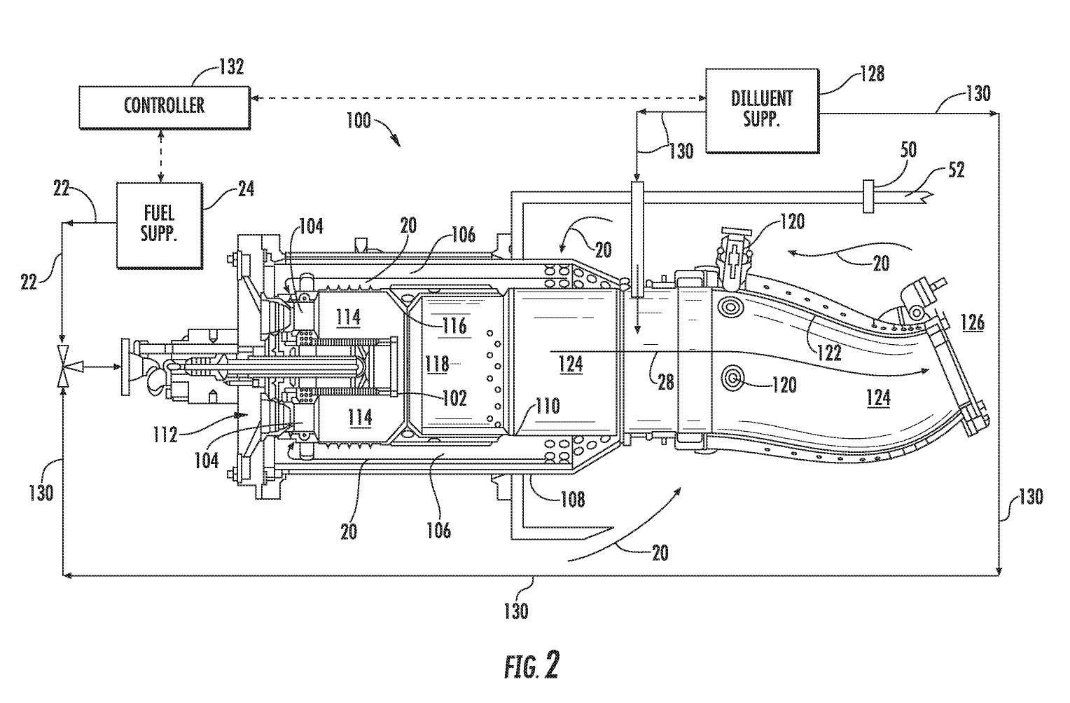

In various embodiments, the combustor 26 is a Dry Low NOx (DLN) type combustor. FIG. 2 provides a cross sectioned side view of an exemplary DLN type combustor 100, as may be incorporated into the gas turbine 12 in place of combustor 26 as shown in FIG. 1. In particular embodiments, as shown in FIG. 2, the combustor 26 is a DLN-1 or a DLN-1+ type combustor 100 as manufactured by the General Electric Company, Schenectady, N.Y. A fuel injection system for the combustor 100 includes a secondary or center fuel nozzle 102 and multiple primary fuel nozzles 104 organized radially and annularly around the center fuel nozzle 102. In operation, a portion of the compressed air 20 from the compressor (FIG. 1) is channeled from the compressor discharge casing 52 through an annular flow channel 106 defined between a flow sleeve 108 and one or more combustion liners 110. The compressed air 20 reverses flow direction at an end cover or head end portion 112 of the combustor 100 and flows through and/or around the primary fuel nozzles 104 and the center fuel nozzle 106.

As shown in FIG. 2, the DLN combustor 100 includes primary combustion zones or premixing chambers 114 that are formed downstream from each primary fuel nozzle 104 and upstream from a venturi 116 which is at least partially formed by one or more of the combustion liners 110. The combustor 100 also includes a secondary or premix combustion zone 118 which is defined downstream from the primary combustion zones 114 and downstream from the center fuel nozzle 102. The primary fuel nozzles 104 and the center fuel nozzle 102 are in fluid communication with the fuel supply system 24 via various fluid conduits, flow control valves and/or couplings.

The fuel supply system 24 may be configured to provide the same fuel type such as natural gas or liquid fuel to both the primary fuel nozzles 104 and the center fuel nozzle 106. In certain configurations, the fuel supply system 24 may be configured to provide different fuel types such as natural gas and/or a liquid fuel to the primary fuel nozzles 104 and/or the center fuel nozzle 102.

During operation, the combustor 100 operates in and transitions between various modes of operation. These modes of operation are generally related to the load placed on the gas turbine and/or the steam output requirement for the power plant 10. The DLN type combustor 100 as shown in FIG. 2, generally operates or transitions between a primary mode of operation, a lean-lean mode of operation, a secondary mode of operation and a premix mode of operation depending on the load level required of the gas turbine 12 and/or the steam output requirements of the power plant 10. As used herein, the term “non-premix mode of operation” refers to an operating mode of the combustor 100 that is either the primary, lean-lean or the secondary operating mode up to a point of transition to the premix mode. In addition, “non-premix mode of operation” may include any transient mode of operation which occurs between the primary, lean-lean and the secondary modes of operation.

The primary mode of operation typically occurs from ignition up to about thirty percent of full load. During primary mode of operation the fuel supply system 24 provides one hundred percent of the total fuel flow to the combustor 100 to the primary fuel nozzles 104. As a result, combustion during the primary mode of operation takes place primarily in the primary combustion zones 114. The primary mode of operation is used to ignite, accelerate and operate the gas turbine 12 over low-loads to mid-loads, up to a pre-selected combustion reference temperature.

The lean-lean mode of operation typically occurs from about thirty percent to about seventy percent of full load. During lean-lean operation the fuel supply system 24 may split the total fuel flow between the primary fuel nozzles 104 and the center fuel nozzle 102. For example, the fuel supply system 24 may provide about seventy percent of the total fuel flow to the primary fuel nozzles 104 and about thirty percent of the total fuel flow to the center fuel nozzle 102. As a result, combustion during the lean-lean mode of operation takes place in both the primary combustion zones 114 as well as the secondary combustion zone 118. This mode of operation is used for intermediate loads between two pre-selected combustion reference temperatures.

The secondary mode of operation generally occurs when the combustor 100 transitions between the lean-lean mode of operation and a premix mode of operation. During the secondary mode of operation the fuel supply system 24 may decrease the fuel flow to the primary fuel nozzles 104 from about seventy percent to about zero percent of total fuel flow to the combustor 100 while increasing the fuel flow to the center fuel nozzle 102 from about thirty percent to about one hundred percent of the total fuel flow, thus allowing the flames associated with the primary combustion zones 114 to extinguish while maintaining a flame in the secondary combustion zone 118 which originates from the center fuel nozzle 102. This mode is necessary to extinguish the flame in the primary combustion zones 114.

When the combustor 100 is operating in the premix mode of operation, the fuel split between the primary fuel nozzles 104 and the center fuel nozzle 102 may be modified such that the primary fuel nozzles 104 receive about eighty percent of the total fuel flow to the combustor 100 while the center fuel nozzle 102 may receive about twenty percent of the total fuel flow to the combustor 100. The fuel 22 flowing to the primary fuel nozzles 102 is premixed with the compressed air 20 from the compressor 18 (FIG. 1) within the primary combustion zones 114 which are at this point primary premix zones 114 to form a fuel lean fuel/air mixture therein. The lean premixed fuel/air mixture then flows through the venturi 116 and into the secondary combustion zone 118 where it is ignited by the flame from the center fuel nozzle 102. This mode of operation is achieved at and near the combustion reference temperature design point. Optimum emissions are generated in the premix mode.

The load ranges associated with the primary, lean-lean, secondary and premix modes of operation may shift from the ranges provided above based on various factors. For example, the load ranges may vary with a degree of inlet guide vane (IGV) modulation and, to a smaller extent, with the ambient temperature of air 16. For instance, at ISO ambient, the premix mode of operation operating range may be from about 50% to 100% load with IGV modulation down to about 42°, and about 75% to 100% load with IGV modulation down to about 57°. The various fuel splits provided herein with regards to the various modes of operation are exemplary and not meant to be limiting unless otherwise specified in the claims.

In particular embodiments, as shown in FIG. 2, the combustor 100 includes a plurality of axially staged fuel injectors 120, also known as Late Lean Injectors (LLI), annularly arranged around a transition duct 122 that extends downstream from the combustion liner(s) 110. The combustion liner(s) 110 and the transition duct 122 at least partially define a hot gas path 124 through the combustor 100 that extends to an inlet 126 of the turbine (FIG. 1). The fuel injectors 120 provide for fluid communication through the transition duct 122 into the hot gas path 124. The fuel injectors 120 may extend into the transition duct 122 and/or the hot gas path 124 at varying radial depths.

Each or at least some of the fuel injectors 120 may be configured to provide Late Lean or axial fuel staging capability to the combustor 100. That is, the fuel injectors 120 are each configured to supply a fuel and/or fuel/air mixture to the hot gas path 124 in a direction that is generally transverse to a predominant flow direction of the combustion gases 28 flowing through the hot gas path 124. In so doing, conditions within the combustor 100 and the hot gas path 124 are staged to create local zones of stable combustion while reducing the formation of NOx emissions, thus enhancing overall performance of the combustor 100.

In various embodiments, as shown in FIG. 2, the combustor 100 may be fluidly coupled to a diluent supply 128. The diluent supply 128 may provide a diluent 130 such as steam, water or nitrogen to the combustor 100 upstream or downstream from the primary fuel nozzles 104 and/or the center fuel nozzle 102. For example, in particular embodiments, the diluent supply 128 may be configured to inject the diluent 130 directly into the hot gas path 124 downstream from the secondary combustion zone 118 and upstream from the plurality of fuel injectors 120. In particular embodiments, the diluent supply 128 may be configured to inject the diluent 130 into the fuel 22 upstream from the primary fuel nozzles 104 and/or the center fuel nozzle 102. The diluent 130 may be used to reduce NOx emissions levels and/or enhance combustor performance during premix and non-premix mode of operation and/or during base load, peak-load or low-load operating conditions.

As shown in FIGS. 1 and 2 collectively, the fuel supply system 24, the diluent supply 128 and/or the HRSG 42 may be electronically coupled to a controller 132. The controller 132 may be programmed to direct the fuel supply system 24 to supply or split the fuel 22 flowing to the primary fuel nozzles 104 and the center fuel nozzle 102 at similar flow rates and at different flow rates based at least on part on gas turbine load and/or power plant 10 steam requirements.

The controller 132 may incorporate a General Electric SPEEDTRONIC™ Gas Turbine Control System, such as is described in Rowen, W. I., “SPEEDTRONIC™ Mark V Gas Turbine Control System”, GE-3658D, published by GE Industrial & Power Systems of Schenectady, N.Y. Controller 132 may also incorporate a computer system having a processor(s) that executes programs stored in a memory to control the operation of the gas turbine using sensor inputs and instructions from human operators. The programs executed by controller 132 may include scheduling algorithms for regulating fuel flow to the combustor 100, regulating flow of the diluent 130 to the combustor 100, regulating bleed or bypass air from the compressor 18 and/or the compressor discharge casing 52, inlet guide vane 58 angle, steam output and for reducing combustion related emissions. The commands generated by controller 132 may cause valves to actuate between open and closed positions to regulate the flow of fuel, bleed air and diluent and may cause actuators to adjust angle of the inlet guide vanes 58.

The controller 132 may regulate the gas turbine 12 based, at least in part, on a database stored in the memory of the controller 132. This database may enable the controller 132 to maintain the NOx and CO emissions in the gas turbine exhaust section 38 to within certain predefined limits during turndown operation, to maintain a predefined steam output and to maintain the combustor 100 within suitable stability boundaries. The controller 132 may set operational parameters such as the gas turbine load, steam production requirements, bleed air flow rate, flow of diluent and combustor fuel split so as to: 1) achieve the desired emissions levels while operating in a non-premix or turndown mode and/or operating between a full speed no load (FSNL) condition up to a base load condition; while 2) eliminating the need for inlet bleed heating.

During base load or peak load, the combustor 100 is operated in the premix mode. While in this operating mode, emissions levels are generally maintained within desired acceptable emissions levels and operation of the HRSG 42 is optimized to provide sufficient steam flow to drive the steam turbine 48 and/or support various secondary operations. During non-peak load demand such as during turndown operation, operators may wish to operate the gas turbine to reduce time required to bring the gas turbine back online for power generation. However, during turndown operation of the gas turbine 12 emissions levels increase. Therefore, in order to reduce emissions levels, operators typically inject bleed air into a bleed air system to increase the inlet temperature of air 16 upstream from the compressor, thereby reducing the formation of NOx.

However, in various embodiments as presented herein, during turndown operation an operator, either manually or via the controller 132, may bleed compressor air 20 from at least one of the compressor 18 or the compressor discharge casing 52 via one or more of the bleed air extraction ports 50, thereby reducing the pressure of the compressed air 20 within the combustor 100 and thus preventing flame blow out and stabilizing the combustion flames. At the same time, the fuel injectors 120 may be energized to inject fuel or a fuel/air mixture into the combustion gases 28 so as to reduce NOx emissions. In this manner, inlet air heating is not required to maintain NOx emissions at compliance levels during non-premix mode of operation and/or during turndown operation. The bleed air may be routed to at least one of the inlet system 14, the turbine 30 or the exhaust section 38. In particular embodiments, the bleed air may be used to add thermal energy to the exhaust gases 36 upstream from the HRSG 42.

In particular embodiments, the diluent 130 (i.e. steam, water, nitrogen, etc. . . . ) may be injected into the fuel 22 upstream form the primary fuel nozzles 104 and the center fuel nozzle 102 and/or may be injected into the combustion gases 28 within the hot gas path 124 via the diluent supply 128 to reduce NOx production within the hot gas path 124. In addition, the fuel injectors 120 may inject the fuel or fuel/air mixture into the hot gas path 124 downstream from the secondary combustion zone 118, thus reducing NOx within the combustion gases 28. The oxidation catalyst system 56 may be activated to further reduce various undesirable emissions such as carbon monoxide (CO) from the exhaust gases 36 downstream from the premix duct burner 60 at less than base load condition as they flow through the exhaust section 36 towards the exhaust stack 40. In this configuration, desired levels of steam output from the power plant 10 may be maintained while mitigating the emissions levels at less than base load or non-premix operating conditions such as during gas turbine turndown.

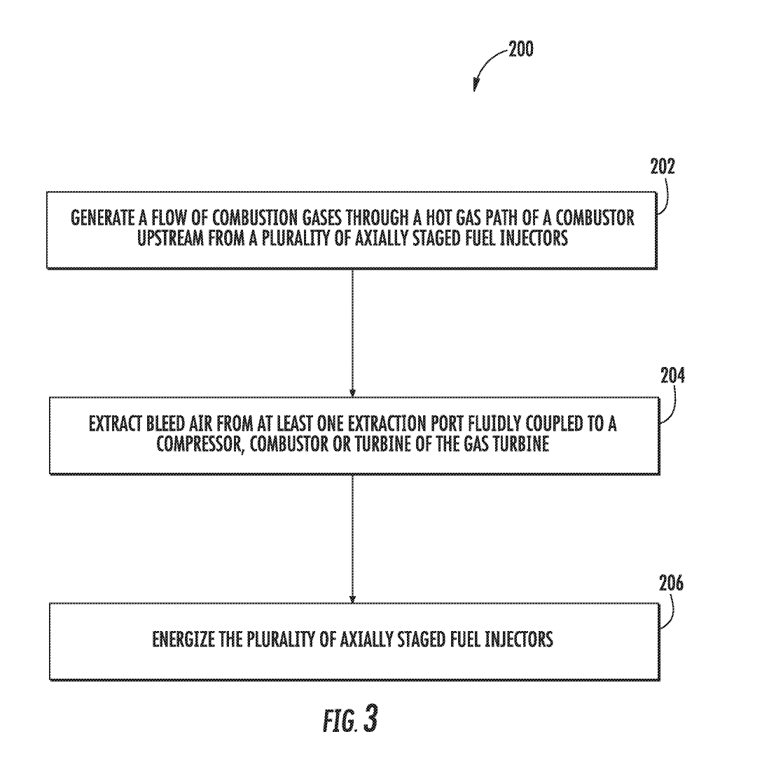

The various embodiments and figures described herein provide one or more methods for maintaining emissions compliance while operating a gas turbine in turndown mode. FIG. 3 provides a block diagram of one method 200 for maintaining emissions compliance while operating a gas turbine in turndown mode according to one embodiment of the present disclosure. As shown in FIG. 3 at step 202, method 200 includes burning fuel 22 to generate the flow of combustion gases 28 through the hot gas path 124 of the combustor 100 where the fuel 22 is burned in at least one of the primary combustion zone 114 and the secondary combustion zone 118 of the combustor 100 and where the primary combustion zone 114 and the secondary combustion zone 118 are formed upstream from the plurality of axially staged fuel injectors 120. At step 204, method 200 includes extracting bleed or compressed air 20 from at least one extraction port 50 which is fluidly coupled to the compressor 18, the compressor discharge casing 52 or the turbine 30. At step 206, method 200 includes energizing the plurality of axially staged fuel injectors 120.

In particular embodiments, method 200 may include injecting diluent 130 into the primary combustion zone 114 via one or more primary fuel nozzles 104 of the plurality of primary fuel nozzles 104. In particular embodiments, method 200 may include injecting diluent 130 into the secondary combustion zone 118 via the center fuel nozzle 102. In particular embodiments, method 200 may include injecting diluent 130 into the hot gas path 124 downstream from the center fuel nozzle 102 and upstream from the plurality of axially staged fuel injectors 120. In particular embodiments, injecting the diluent 130 into the hot gas path 124 comprises injecting at least one of water, steam and nitrogen into the combustor 100.

In particular embodiments, method 200 may include scrubbing the flow of combustion gases 28 via an oxidation catalyst system 56 disposed downstream from the turbine 30. In particular embodiments, method 200 may include directing the bleed air 20 into the turbine 30. In particular embodiments, method 200 may include opening inlet guide vanes 58 so as to increase combustion gas flow rate.

Although specific embodiments have been illustrated and described herein, it should be appreciated that any arrangement, which is calculated to achieve the same purpose, may be substituted for the specific embodiments shown and that the invention has other applications in other environments. This application is intended to cover any adaptations or variations of the present invention. The following claims are in no way intended to limit the scope of the invention to the specific embodiments described herein.

What is claimed:

1. A system for maintaining emissions compliance while operating a gas turbine in turndown mode, comprising:
a gas turbine including, in serial flow order, a compressor, a combustor, a turbine and an exhaust section, wherein the combustor comprises a plurality of axially staged fuel injectors positioned downstream from a plurality of primary fuel nozzles and a center fuel nozzle, the gas turbine further comprising a bleed air extraction port, wherein the bleed air extraction port is in fluid communication with at least one of the compressor, a compressor discharge casing or the combustor; and
a controller programmed to bleed compressed air from the bleed air extraction port and to energize the plurality of axially staged fuel injectors during turndown operation of the gas turbine.

2. The system as in claim 1, wherein the bleed air extraction port is fluidly coupled to the compressor and to the turbine via a bleed air inlet port.

3. The system as in claim 1, wherein the bleed air extraction port is fluidly coupled to the compressor and to the exhaust section upstream from a heat recovery steam generator via a bleed air inlet port.

4. The system as in claim 1, wherein the bleed air extraction port is fluidly coupled to the combustor and to the turbine via a bleed air inlet port.

5. The system as in claim 1, wherein the bleed air extraction port is fluidly coupled to the combustor and to the exhaust section upstream from a heat recovery steam generator via a bleed air inlet port.

6. The system as in claim 1, further comprising an oxidation catalyst system, wherein the oxidation catalyst system is disposed within the exhaust section.

7. The system as in claim 1, further comprising a diluent injection system having a diluent supply in fluid communication with a hot gas path of the combustor, wherein the diluent supply provides a diluent comprising at least one of steam, water and nitrogen to the combustor.

8. The system as in claim 7, wherein the diluent supply is in fluid communication with at least one of the primary fuel nozzles.

9. The system as in claim 7, wherein the diluent supply is fluidly coupled to the combustor at a location downstream from the primary fuel nozzles and upstream from the plurality of axially staged fuel injectors.

10. The system as in claim 1, further comprising a plurality of inlet guide vanes disposed at an inlet of the compressor.

11. A method for maintaining emissions compliance while operating a gas turbine in turndown mode, comprising:
burning a fuel to generate a flow of combustion gases through a hot gas path of a combustor, wherein the fuel is burned in at least one of a primary combustion zone and a secondary combustion zone of the combustor, wherein the primary combustion zone and the secondary combustion zone are formed upstream from a plurality of axially staged fuel injectors;
extracting bleed air from at least one extraction port fluidly coupled to a compressor, the combustor or a turbine of the gas turbine; and
energizing the plurality of axially staged fuel injectors.

12. The method as in claim 11, further comprising injecting a diluent into the primary combustion zone via a plurality of primary fuel nozzles.

13. The method as in claim 11, further comprising injecting a diluent into the secondary combustion zone via a center fuel nozzle.

14. The method as in claim 11, further comprising injecting a diluent into the hot gas path downstream from a center fuel nozzle and upstream from the plurality of axially staged fuel injectors.

15. The method as in claim 14, wherein injecting the diluent into the hot gas path comprises injecting at least one of water, steam and nitrogen into the combustor.

16. The method as in claim 11, further comprising scrubbing the flow of combustion gases via an oxidation catalyst system disposed downstream from the turbine.

17. The method as in claim 11, further comprising directing the bleed air into the turbine.

18. The method as in claim 11, further comprising opening inlet guide vanes disposed at an inlet to the compressor so as to increase combustion gas flow rate.
